(19) United States
(12) Patent Application Publication
(10) Pub. No.: US 2014/0108910 A1
(43) Pub. Date: Apr. 17, 2014

(54) Systems and Methods for Shaping Search Engine Results

(71) Applicant: Charles C. Martin, Denham Springs, LA (US)

(72) Inventor: Charles C. Martin, Denham Springs, LA (US)

(21) Appl. No.: 13/654,405

(22) Filed: Oct. 17, 2012

(51) Int. Cl. G06F 17/22

(52) U.S. Cl. CPC G06F 17/2247
USPC 715/234

(57) ABSTRACT

A computer-implemented method for shaping internet search results, having the steps of acquiring the rights to a domain name, the domain name having a website URL; generating a website corresponding to the domain name; obtaining account information from a user; receiving a profile name; validating the profile name; creating a third-level profile website; amending the domain of the profile website URL with a profile name; and publishing the profile website, where the method is performed by one or more processors.

### CROSS-REFERENCE TO RELATED APPLICATION

This application claims the benefit of priority to U.S. Provisional Application No. 61/548,070 filed on Oct. 17, 2011, which is incorporated herein by reference in its entirety.

### BACKGROUND

A website is a collection of web pages, images, videos, and/or other digital assets that is hosted on one or more computer servers, usually accessible via the internet. The World Wide Web constitutes all publicly accessible online websites and has exploded in popularity in recent years as an online presence has become commonplace for businesses, governments and individuals.

Today most businesses, governments, non-profits such as churches and charities, and many individuals have established at least one website located on the World Wide Web to advertise, inform, and communicate with the public, potential customers, current customers, or third parties. However, a person can post on a website negative and often untrue information about a business, government, non-profit, or individual. These negative postings can be very damaging to an entity's or individual's reputation.

### SUMMARY

The present disclosure pertains to a computer-implemented method for shaping internet search results, having the steps of acquiring the rights to a domain name, the domain name having a website URL; generating a website corresponding to the domain name; obtaining account information from a user; receiving a profile name; validating the profile name; creating a third-level profile website; amending the domain of the profile website URL with a profile name; and publishing the profile website, where the method is performed by one or more processors.

One aspect of the disclosure is a method where the domain name comprises a second-level domain name and a third-level domain name. Another aspect of the disclosure is a method where the step of generating a website corresponding to the second-level domain name and third-level domain name comprises generating second-level profile website corresponding to the second-level domain name and generating a third-level profile website corresponding to the third-level domain name.

Another aspect of the disclosure is a method where the profile name is used for amending a third-level domain of the profile website URL. Another aspect of the disclosure is a method where the profile name is used for amending a plurality of third-level domains of the profile website URL. Another aspect of the disclosure is a method where a plurality of profile names are used for amending a plurality of third-level domains of the profile website URL.

Another aspect of the disclosure is a method where amending the domain of the profile website URL with a profile name comprises rewriting the third-level domain of the profile web site URL with the profile name.

Another aspect of the disclosure is a method having the step of receiving new post information. Another aspect of the disclosure is a method having the step of receiving new link information. Another aspect of the disclosure is a method having the step of creating meta tags associated with the profile website. Another aspect of the disclosure is a method having the step of presenting a search field to the user. Another aspect of the disclosure is a method where having the step of receiving report information. Another aspect of the disclosure is a method where report information is a keyword for determining a keyword phrase ranking. Another aspect of the disclosure is a method having the step of notifying the user when a keyword is reference in an undesirable website.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a schematic view of an electronic device according to an exemplary embodiment.

FIG. 2 is a process of shaping search engine results according to an exemplary embodiment.

FIG. 3 is a schematic view of functions available to the user according to an exemplary embodiment.

FIG. 4 is a schematic view of functions available to the user according to an exemplary embodiment.

FIG. 5 is a schematic view of functions available to the user according to an exemplary embodiment.

FIG. 6 is a schematic view of functions available to the user according to an exemplary embodiment.

FIG. 7 is a schematic view of functions available to the user according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure pertains to systems and methods for shaping internet search results generated by search engines in response to user queries. Several embodiments of the invention pertain to one or more centralized web-based software solutions that shape search engine results with respect to a specific user query. More specifically, embodiments of the current system alter the ranking of search engine results by the creation of at least one profile website and/or generate a search engine presence or profile.

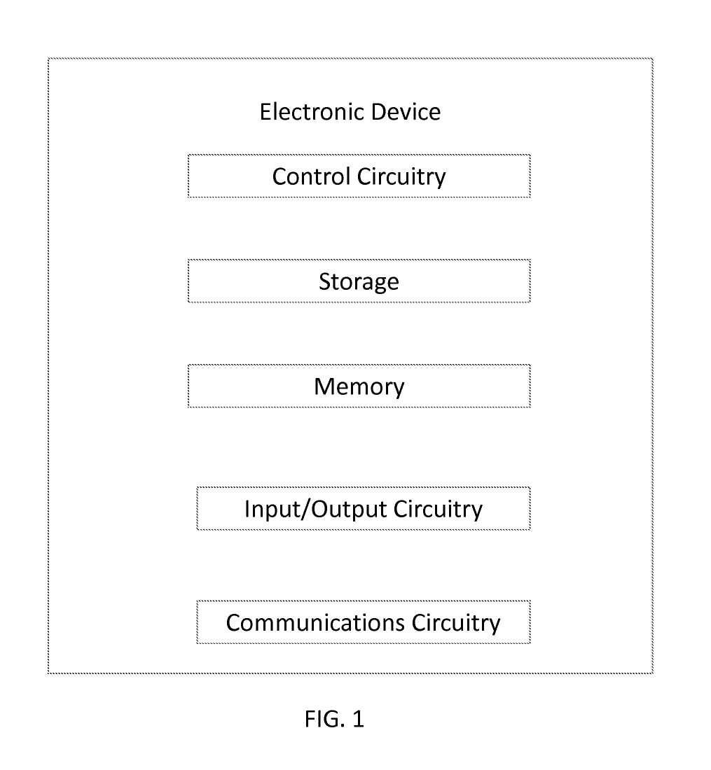

FIG. 1 shows an illustrative electronic device for providing an application for interfacing with a host. Electronic device can include control circuitry, storage, memory, input/output (“I/O”) circuitry, and communications circuitry. In some embodiments, one or more of the components of the electronic device can be combined or omitted (e.g., storage and memory may be combined). In some embodiments, the electronic device can include other components not combined or included in those shown in FIG. 1 (e.g., a display), or several instances of the components shown in FIG. 1. Only one of each of the components is shown in FIG. 1.

The electronic device can include any suitable type of electronic device. For example, the electronic device can include a substantially fixed electronic device, such as a desktop computer. As another example, electronic device can include a larger portable electronic device, such as a laptop or tablet computer. As another example, the electronic device can include a portable electronic device that the user may hold in his or her hand, such as a digital media player, a personal e-mail device, a personal data assistant (“PDA”), a cellular telephone, a handheld gaming device, or a digital camera.

Control circuitry can include any processing circuitry or processor operative to control the operations and performance of the electronic device. For example, control circuitry can be used to run operating system applications, firmware applications, media playback applications, media editing applications, or any other application. In some embodiments, control circuitry can drive a display and process inputs received from a user interface.

Storage can include, for example, one or more storage mediums including a hard-drive, solid state drive, flash memory, permanent memory such as ROM, any other suitable type of storage component, or any combination thereof. Storage can store, for example, media data (e.g., music and video files), application data (e.g., for implementing functions on the electronic device), firmware, user preference information data (e.g., account information), authentication information (e.g. libraries of data associated with authorized users), wireless connection information data (e.g., information that can enable the electronic device to establish a wireless connection), and any other suitable data or any combination thereof.

Memory can include cache memory, semi-permanent memory such as RAM, and/or one or more different types of memory used for temporarily storing data. In some embodiments, memory can also be used for storing data used to operate electronic device applications, or any other type of data that can be stored in storage. In some embodiments, memory and storage can be combined as a single storage medium.

I/O circuitry can be operative to convert (and encode/decode, if necessary) analog signals and other signals into digital data. In some embodiments, I/O circuitry can also convert digital data into any other type of signal, and vice-versa. For example, I/O circuitry can receive and convert physical contact inputs (e.g., from a multi-touch screen), physical movements (e.g., from a mouse or sensor), analog audio signals (e.g., from a microphone), or any other input. The digital data can be provided to and received from control circuitry, storage, memory, or any other component of electronic device. Although I/O circuitry is illustrated in FIG. 1 as a single component of electronic device, several instances of I/O circuitry can be included in electronic device.

Electronic device can include any suitable interface or component for allowing a user to provide inputs to I/O circuitry. For example, electronic device can include any suitable input mechanism, such as for example, a button, keypad, dial, a click wheel, or a touch screen. In some embodiments, electronic device can include a capacitive sensing mechanism, or a multi-touch capacitive sensing mechanism.

In some embodiments, electronic device can include specialized output circuitry associated with output devices such as, for example, one or more audio outputs. The audio output can include one or more speakers (e.g., mono or stereo speakers) built into electronic device, or an audio component that is remotely coupled to electronic device (e.g., a headset, headphones or earbuds that can be coupled to communications device with a wire or wirelessly).

In some embodiments, I/O circuitry can include display circuitry (e.g., a screen or projection system) for providing a display visible to the user. For example, the display circuitry can include a screen (e.g., an LCD screen) that is incorporated into electronic device. As another example, the display circuitry can include a movable display or a projecting system for providing a display of content on a surface remote from electronic device (e.g., a video projector). In some embodiments, the display circuitry can include a coder/decoder (Codec) to convert digital media data into analog signals. For example, the display circuitry (or other appropriate circuitry within the electronic device) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry. Alternatively, the display circuitry can be operative to provide instructions to a remote display.

Communications circuitry can include any suitable communications circuitry operative to connect to a communications network and to transmit communications (e.g., voice or data) from electronic device to other devices within the communications network. Communications circuitry can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, communications circuitry can be operative to create a communications network using any suitable communications protocol. For example, communications circuitry can create a short-range communications network using a short-range communications protocol to connect to other devices. For example, communications circuitry can be operative to create a local communications network using the Bluetooth® protocol to couple electronic device with a Bluetooth® headset.

Electronic device can include one or more instances of communications circuitry for simultaneously performing several communications operations using different communications networks, although only one is shown in FIG. 1. For example, electronic device can include a first instance of communications circuitry for communicating over a cellular network, and a second instance of communications circuitry for communicating over Wi-Fi or using Bluetooth®. In some embodiments, the same instance of communications circuitry can be operative to provide for communications over several communications networks.

In one embodiment, the electronic device may include an application to interface with at least one server thereby providing the electronic device with the ability to create, edit, and amend profile websites. For example, through the application of the electronic device, the user can connect to a host server, payment processor server, or the like. The host server can be any server that receives and transmits communication between the electronic device and the host. For example, the host server can receive communication from the host and transmit the communication to the electronic device. The payment processor server can be any server associated with a company that conducts financial transactions, for example, Paypal, credit card companies, banks, or the like. In one embodiment, the payment processor server communicates directly with the electronic device.

Communication between the electronic device and the host server, and between the electronic device and payment processor server may be accomplished through any suitable network that may be provided by one or more communication interface, for example, WLAN, WAN, or LAN connection. Specifically, by way of example, the network may be a wireless internet connection established by way of the WLAN interface, a local area network connection established through the LAN interface, or a wide area network connection established by way of the WAN interface, which may include one of various WAN mobile communication protocols, such as a General Packet Radio Service (GPRS) connection, an EDGE connection (Enhanced Data rates for GSM Evolution connection), or a 3G connection, such as in accordance with the IMT-2000 standard. One or more of the data encryption techniques and security protocols (e.g., SSL or TSL protocols) may be further utilized in order to facilitate the secure transmission of the data (e.g. account information) from the electronic device to the host server.

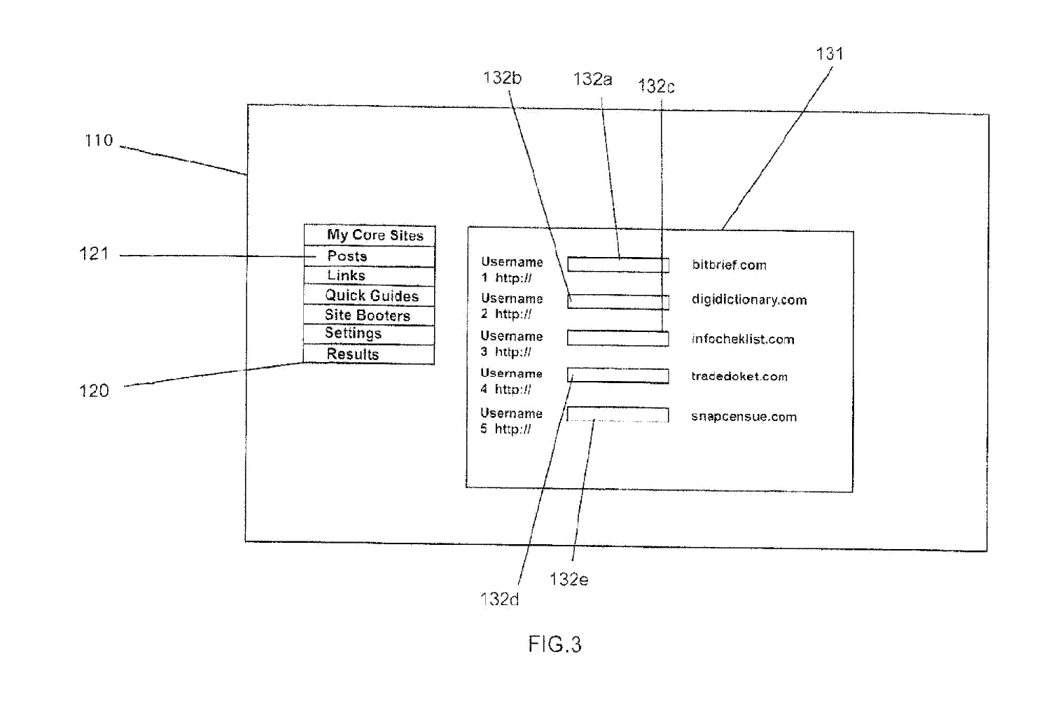

FIG. 3-7 show an example user interface 110 for a database application. The user interface 110 can provide a collection of user interface elements that give a user the tools needed to input, organize, query, browse, and/or view the content of a database. In one embodiment, the user interface elements, for example, drop-down menus, static menus, check boxes, buttons, tabs, input boxes, or the like, are associated with a profile website and is representative of databases that can be accessed through the user interface 110. The user interface 110 can include a list control 120 that shows a collection of list items 121, for example, posts, links, quick guides, site boosters, settings, or the like, that can be representative of databases accessed through the user interface 110. A list item 121 can correspond to a user window having, for example, profile window 131, new post window 141, new link window 151, comment window 161, reporting window 171, or the like, whereby clicking a list item 121 causes a user window to be presented.

In one embodiment, a user window can provide a collection of user items that give a user the tools needed to input, organize, query, browse, and/or view the content of a database. For example, the profile window 131 has profile items 132, for example, drop-down menus, static menus, check boxes, buttons, tabs, input boxes, or the like, where each profile item 132 can receive profile information associated with a profile website and is representative of databases that can be accessed through the profile window 131. Profile information can be any information associated with a profile website, for example, a profile name.

By way of another example, the new post window 141 can provide a collection of new post items 142 that give a user the tools needed to input, organize, query, browse, and/or view the content of a database. In one embodiment, the new post window 141 has new post items 142, for example, drop-down menus, static menus, check boxes, buttons, tabs, input boxes, or the like, where each new post item 142 receives new post information associated with a posting on a profile website and is representative of databases that can be accessed through the new post window 141. Profile websites can be linked or associated in a manner that allows for a user to post a posting on a plurality of profile websites. New post information can be any information associated with a new post for example content.

By way of another example, the new link window 151 can provide a collection of new link items 152 that give a user the tools needed to input, organize, query, browse, and/or view the content of a database. In one embodiment, the new link window 151 has new link items 152, for example, drop-down menus, static menus, check boxes, buttons, tabs, input boxes, or the like, where each new link item 152 receives new link information associated with a link (e.g. social media link such as Twitter, Facebook, or the like) on a profile website and is representative of databases that can be accessed through the new link window 151. New link information can be any information associated with a new link, for example a URL.

By way of another example, the comment window 161 can provide a collection of comment items 162 that give a user the tools needed to input, organize, query, browse, and/or view the content of a database. In one embodiment, the comment window 161 has comment items 162, for example, drop-down menus, static menus, check boxes, buttons, tabs, input boxes, or the like, where each comment item 162 receives comment information associated with a comment posted on a profile website thereby allowing a user to moderate a comment posted on a profile website. The comment item 162 is representative of databases that can be accessed through the comment window 161. Comment information can be any information associated with a comment, for example the text of a comment.

By way of another example, the report window 171 can provide a collection of report items 172 that give a user the tools needed to input, organize, query, browse, and/or view the content of a database. The report items 172 can be drop-down menus, static menus, check boxes, buttons, tabs, input boxes, or the like for choosing or receiving the report information for creating a report. The report items 172 can have corresponding record fields in the database. The report window 171 can display report information associated with the profile website. In one embodiment, the report information displayed in the report window 171 can be transmitted as an electronic document or printed as a hard copy. Report information can be any information associated with a report, for example, a keyword.

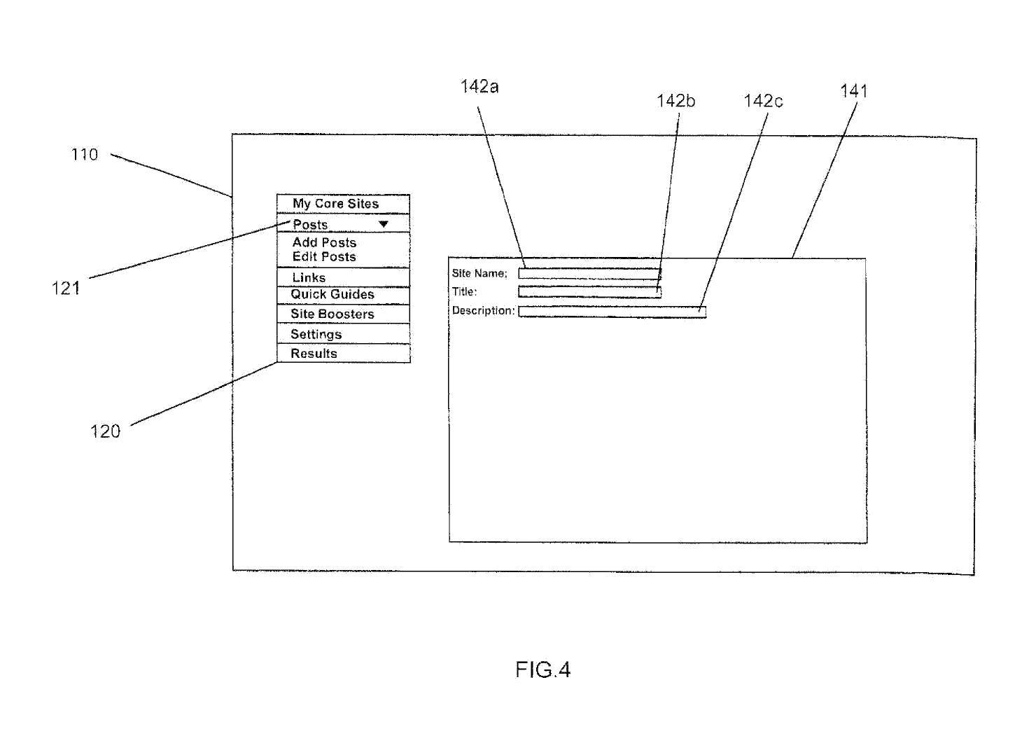

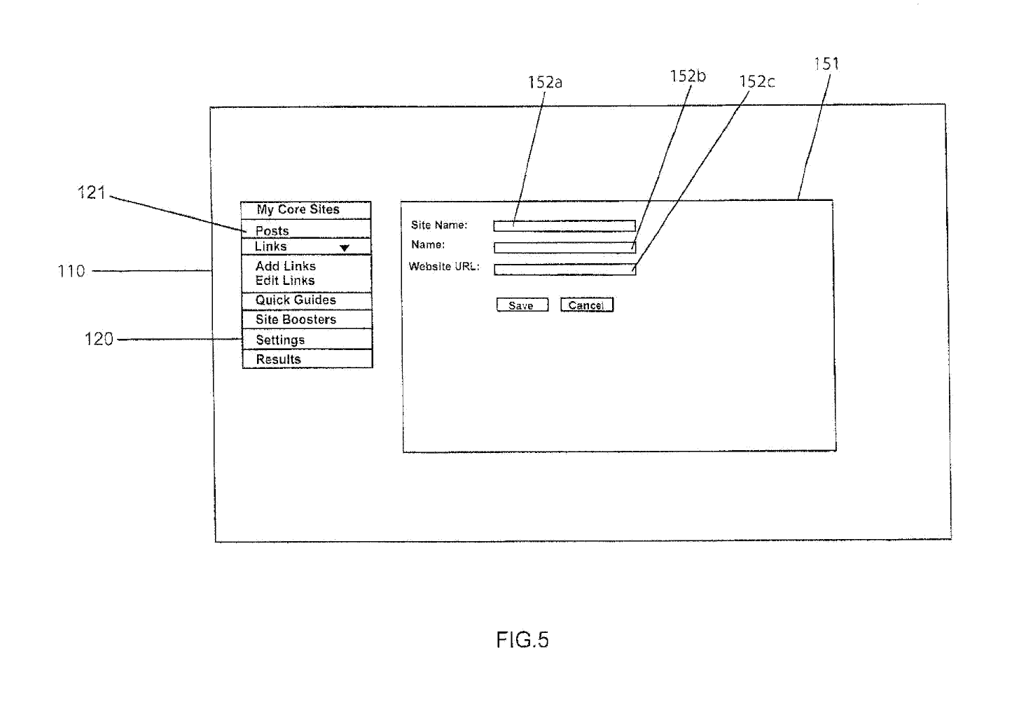

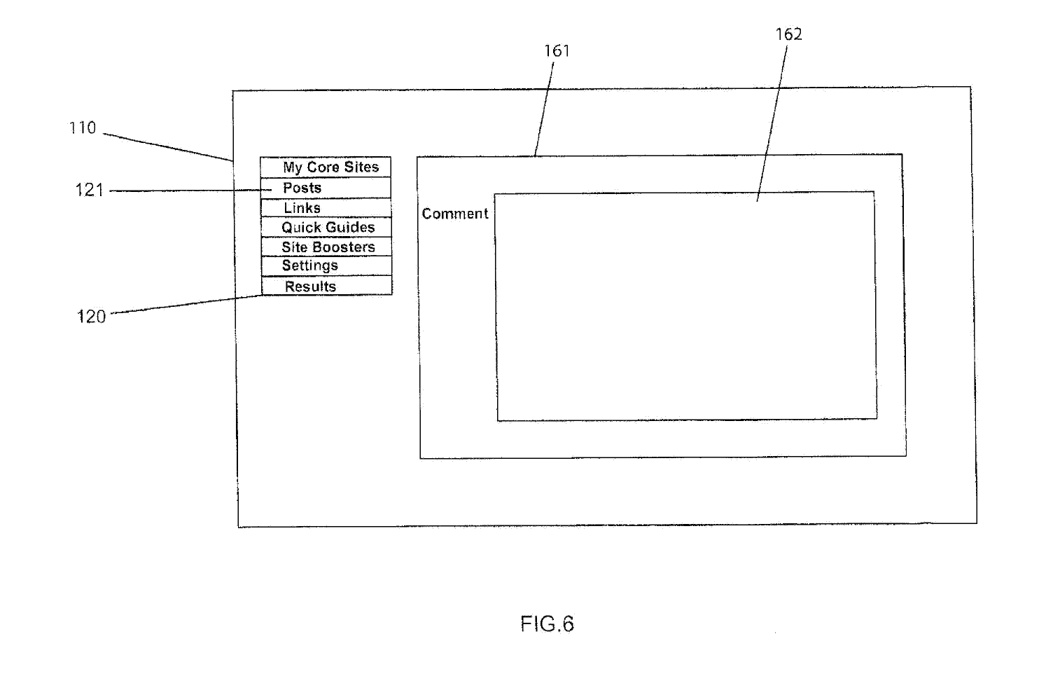

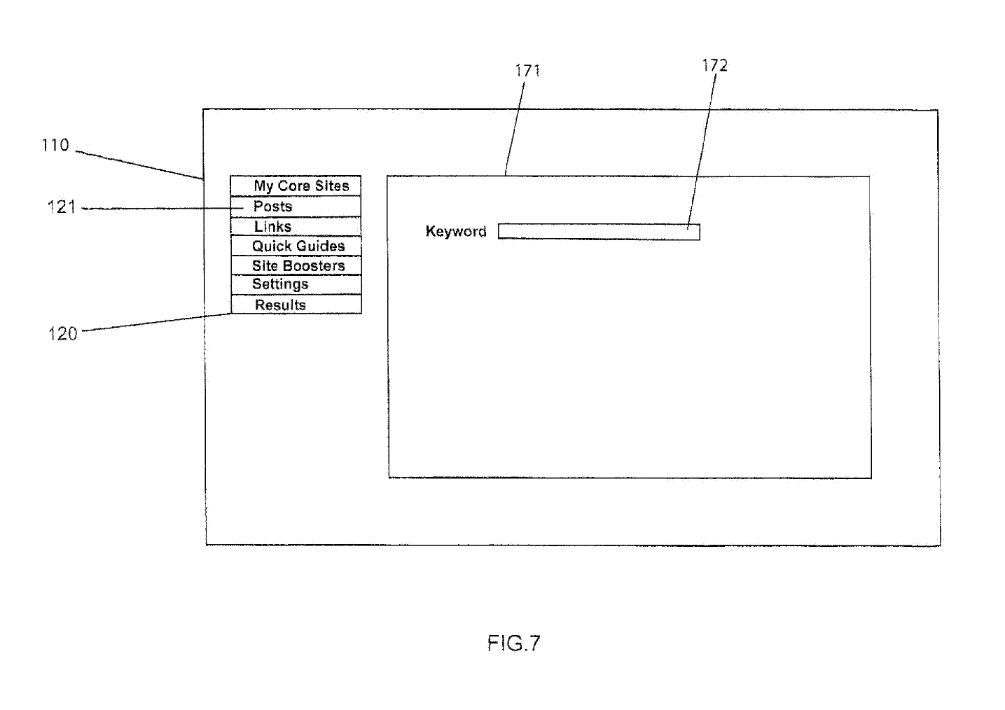

In one embodiment, the input items, for example, profile items 132, new post items 142, new link items 152, comment items 162, and report items 172, associated with the user window receive profile information, new post information, new link information, comment information, and report information with regard to profile websites. For example, as shown in FIG. 3, the profile window 131 has profile items 132a-e for receiving the profile name. By way of another example, as shown in FIG. 4, the new post window 141 has site name item 142a for receiving the profile name, title item 142b for receiving the name of the post, and a description item 142c for receiving a description of the profile website. By way of another example, as shown in FIG. 5, the new link window 151 has a site name item 152a for receiving the profile website to which the new link is associated, a name item 152b for receiving the title of the link, and a URL item 152c for receiving the URL of the new link. By way of another example, as shown in FIG. 6, the comment window 161 has a comment item 162 for monitoring a comment. By way of another example, as shown in FIG. 7, the report window 171 has a report item 171 for receiving a keyword. These input items can have corresponding record fields in the database.

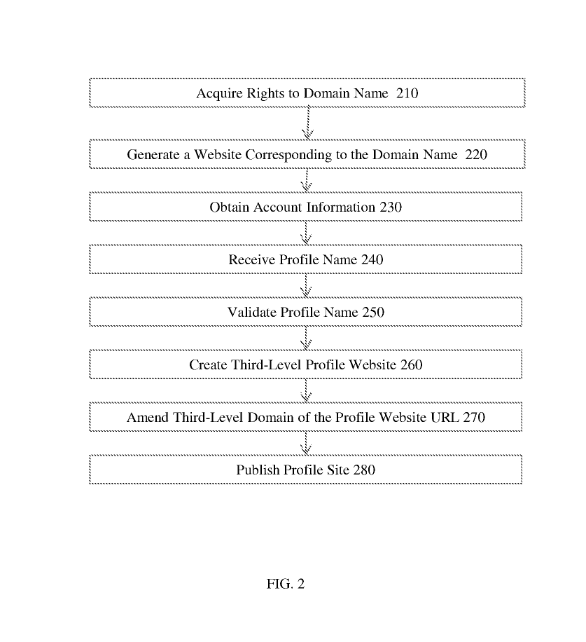

FIG. 2 is a flowchart of an exemplary method for shaping search engine results. In one embodiment, as shown as block 210 of FIG. 2, the method has the step of acquiring the rights to at least one domain name. While the domain name can be any level domain name, the domain name preferably refers to, for example, without limitation, a domain name with a second-level domain name and a third-level domain name. The rights to at least one second-level domain name and at least one corresponding third-level domain name are acquired. In one embodiment, the rights to at least one domain name are acquired prior to the user interacting with the electronic device. In one embodiment, as shown as block 220 of FIG. 2, second-level profile websites, or websites and webpages corresponding to the second-level domain names, are generated. Second-level profile websites are optimized with meta tags, indexable content, or the like to allow the second-level profile websites to rank high in the search engine results of a query. In one embodiment, the user can edit the meta tags.

In one embodiment, as shown as block 230 of FIG. 2, the method has the step of obtaining account information from a user. In one embodiment, the account information is incorporated into an account profile. Account information can include, for example, name, address, payment information, subscription information, email address, phone number, or the like. The application presents input boxes to the user thereby prompting the user to provide the requested information. In one embodiment, the account information is obtained by allowing users to enter account information into an input box of a public web site or a mobile application. Once the login information is obtained, the account information is transmitted to a server and stored on the database, thereby allowing for the account information to be retrieved at a future date. In one embodiment, the application transmits a user name and password from the host server to the electronic device. The account information, user name, password, or the like may be transmitted through e-mail or by way of a messaging system. The transmission can notify the user whether the account profile was successfully created.

In one embodiment, the method has the step of presenting a user window having user items for receiving information from the user. In one embodiment, the user window presented to the user is associated with the selected user item associated with profile website, thereby allowing for the received information to be associated with the profile website. For example, where user interface item was selected and user item is associated with profile website, the information received by way of the user item is associated with the profile website.

In one embodiment, as shown as block 240 of FIG. 2, the method has the step of receiving at least one profile name to be used for amending the third-level domain of the profile website URL. The third-level domain of the profile website URL is the portion of the profile website URL representing the third-level domain of the profile website, for example, without limitation, if the profile website URL is third-level.second-level.com, the third-level domain of the profile website URL is represented as “third-level”. The profile name can be any keyword or index term entered into a search engine as a query, for example, without limitation, name of an individual, business name, product name, location, place of interest, item, phrase containing the name of an individual, business name, product name, location, place of interest, or item, or the like. The profile name can be received by a user entering the profile name into input item 132 of profile window 131.

In one embodiment, the method has the step of receiving a profile name by way of a profile item 132 to be used for amending at least one third-level domain of the profile website URL. For example, where one third-level domain is to be amended by one profile name, the profile name JOHNSMITH is received. By way of another example, where ten third-level domains are to be amended by one profile name, the profile name JOHNSMITH is received. In one embodiment, a plurality of profile names are received whereby each profile name is used to amend at least one third-level domain of the profile website URL. For example, where five third-level domains of a profile website URL are to be amended with five profile names, the profile name JOHNSMITH is used to amend the third-level domain, the profile name JOHNSMITHINATLANTA is used to amend another third-level domain, the profile name JOHNSMITHIHINCHICAGO is used to amend another third-level domain, the profile name JOHNSMITHINDC, and the profile name JOHNSMITHINNEWYORK is used to amend another third-level domain.

In one embodiment, the method has the step of transmitting the profile name to a server and storing the profile name on a database, thereby allowing for the profile name to be retrieved at a future date. For example, the application may send the profile name to database as a record.

In one embodiment, as shown as block 250 of FIG. 2, once the at least one profile name is received, the method has the step of validating at least one profile name to determine whether the profile name has already been used by the host to shape the search engine results. In one embodiment, the application validates the profile name by retrieving the profile name and comparing the profile name of interest with the profile names previously used by the host to shape the search engine results. If no match between the profile name of interest and a previously used profile name exists, the profile name of interest is validated.

In one embodiment, as shown as block 260 of FIG. 2, once the profile name is validated, the method has the step of creating at least one third-level profile website. At least one third-level profile website is created for each second-level profile website. The number of third-level profile websites created can depend on the number of profile websites the host or user desires to create. While any number of third-level profile websites can be created, for example, five, ten, fifteen, twenty, or more, the creation of fifteen third-level profile websites is preferred. In one embodiment, the application creates at least one third-level profile website for each second-level profile website. For example, where second-level.com is available for use, upon the validation of the profile name, the application communicates with the host server to create third-level. second-level.com.

In one embodiment, as shown as block 270 of FIG. 2, once the third-level profile website is created, the method has the step of amending the third-level domain of the profile website URL with a profile name to aid in shaping the search engine results. In one embodiment, the third-level domain of the profile website URL is amended by transmitting the profile name to the host server and rewriting the third-level domain of the profile website URL with the profile name. In one embodiment, a rewrite engine rewrites the third-level domain of the profile web site URL by replacing the original third-level domain of the profile website URL with the profile name thereby creating a new third-level domain of the profile website URL. The rewrite engine can be any software application that changes the appearance of a URL, for example, without limitation, Apache Mod-Rewrite, or the like.

In one embodiment, the method has the step of receiving new post information by way of a new post item 142 to be used for adding content to the profile website. Content can be any information incorporated into a website or webpage, for example, without limitation, text, images, audio, video, maps, contact information, websites, titles, captions, slogans, links, page design images, page design layouts, page design colors, domain name, maps, RSS feeds, or the like. In one embodiment, as shown in FIG. 4, the user inputs content into the profile websites. Content preferably describes interests, activities, work experience, or the like associated with the profile name. Content can be amended, added, or deleted, at any point in time after the original content has been inputted into a profile website.

In one embodiment, the method has the step of receiving new link information by way of a new link item 152 to be used for adding a link to the profile website.

Information used with the system, for example, account profile information, account information, user name, password, content, profile websites, third-level profile website URL, email address, profile information, new post information, new link information, comment information, report information, or the like can be stored on the host server, such as in a secure storage area with the host server using scripting language. The secure storage area can be, for example, without limitation, a MySQL database, XML files, or the like. Scripting language can be for example, without limitation, JavaScript, HyperText Markup Language (HTML), or the like.

In one embodiment, the method has the step of creating meta tags associated with the profile website to aid in shaping the search engine results. Meta tags can be any information used to describe the content of the website or webpage. In one embodiment, the application generates the meta tags from the content inputted on the website by the user. The meta tags are then incorporated into the html code of the profile website to allow the search engine to rank the profile website upon a query. In one embodiment, the user can edit the meta tags of their profile websites.

In one embodiment, as shown as block 280 of FIG. 2, once the content corresponding to a profile website is submitted to the host server, the method has the step of publishing the profile website. In one embodiment, the application publishes the profile website by transmitting a publication message to the host server which in turn publishes the profile website.

In one embodiment, the method has the step of presenting a search field to the user. The search field allows the user to search the text content of all the user's profile websites. A search of the content on the profile website is only as specific as the content supplied by the user. User enters search terms into the search field and initiates a search using the application. The application searches text found in third level domains, posts, post titles, meta tags, or the like.

In one embodiment, the method has the step of receiving comment information by way of comment item 162 thereby allowing a user to moderate a comment posted on a profile website.

In one embodiment, the method has the step of presenting a report window 171 having report items 172 for receiving report information from the user. In one embodiment, the report window 171 presented to the user is associated with the selected user item associated with profile website, thereby allowing for the report information to be associated with the profile website. For example, a user item associated with a profile website provides for the received report information to be associated with the profile website of user item.

In one embodiment, the method has the step of receiving report information. The report information can be received by a user entering the report information into a report item. For example, the user may, via the user window, input the report information associated with profile website into a drop-down menu of the report window. The report information is then transmitted and displayed as described with regard to the transmittal and display of profile information herein.

In one embodiment, the method has the step of receiving at least one keyword for determining a keyword phrase ranking. The keyword can be received by a user entering the keyword into a keyword item. For example, the user may, via the keyword window, input the keyword associated with profile website into an input box of the keyword window. The keyword is then transmitted and displayed as described with regard to the transmittal and display of profile information herein.

In one embodiment, the method has the step of transmitting the keyword to a server and storing the profile information on a database, thereby allowing for the profile information to be retrieved at a future date. For example, the application may send profile information to database as a record.

In one embodiment, the method has the step of retrieving the report information stored as a record in the database and performing an internet search. In one embodiment the internet search is performed utilizing a web search engine or the like thereby resulting in search engine results pages (SERPs) that allow for a determination of the ranking of a profile website. Information contained in the SERPs is then recorded and presented to the user via the report window. The SERPs can be recorded by taking an image snapshot of a search page result, creating an index, or the like. In one embodiment, multiple internet searches on a keyword are performed and recorded thereby allowing for the user to determine the progression of the ranking of a profile website over time. For example, the internet search of the keyword can be performed and recorded in monthly increments allowing a user to track the profile website ranking from month to month.

In one embodiment, the method has the step of transmitting the information related to the SERPs to the report window. For example, information related to the SERPs is stored as a record is retrieved and transmitted to the user window.

In one embodiment, the method has the step of determining when a keyword is referenced in an undesirable website. An undesirable website can be any website, electronic bulletin board, forum, or the like that allows for a visitor to post a comment, rating, review, ranking, or the like, about an individual, business, or the like. A visitor can be a person with an account associated with the website or a unanimous person. The step of determining when a keyword is referenced in an undesirable website can take any form, for example, indexing a search engine utilizing an Application Programming Interface (API), or the like.

In one embodiment, the method has the step of notifying the user when a keyword is reference in an undesirable website. Such a step can include, transmitting an electronic message to the account of the user.

In one embodiment, the method has the step of prompting the user to purchase certain services such as the initial profile websites, additional profile websites, directory blasts, info portal blasts, or the like. Once the user assents to the purchase, the user's payment information is transmitted to host server which transmits the purchase to the payment processor server. The payment processor server completes the processing of the requested transaction in which an amount corresponding to the requested payment is charged to the user's payment account. Once the payment is complete, the payment processor server notifies the host server that the payment is complete. The host server then transmits a completion message to the electronic device notifying the user that the transfer is complete.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A computer-implemented method for shaping internet search results, comprising:
acquiring the rights to a domain name, the domain name having a website URL;
generating a website corresponding to the domain name;
obtaining account information from a user;
receiving a profile name;
validating the profile name;
creating a third-level profile website;
amending the domain of the profile web site URL with a profile name; and
publishing the profile website,
where the method is performed by one or more processors.

2. The method of claim 1 wherein the domain name comprises a second-level domain name and a third-level domain name.

3. The method of claim 2 wherein the step of generating a website corresponding to the second-level domain name and third-level domain name comprises generating second-level profile web site corresponding to the second-level domain name and generating a third-level profile website corresponding to the third-level domain name.

4. The method of claim 1 wherein the profile name is used for amending a third-level domain of the profile web site URL.

5. The method of claim 1 wherein the profile name is used for amending a plurality of third-level domains of the profile website URL.

6. The method of claim 1 wherein a plurality of profile names are used for amending a plurality of third-level domains of the profile website URL.

7. The method of claim 1 wherein amending the domain of the profile website URL with a profile name comprises rewriting the third-level domain of the profile website URL with the profile name.

8. The method of claim 1 further comprising receiving new post information.

9. The method of claim 1 further comprising receiving new link information.

10. The method of claim 1 further comprising creating meta tags associated with the profile website.

11. The method of claim 1 further comprising presenting a search field to the user.

12. The method of claim 1 further comprising receiving report information.

13. The method of claim 12 wherein report information is a keyword for determining a keyword phrase ranking.

14. The method of claim 13 further comprising notifying the user when a keyword is reference in an undesirable website.
